(19) United States
(12) Patent Application Publication
(10) Pub. No.: US 2025/0145038 A1
(43) Pub. Date: May 8, 2025

(54) METHOD AND SYSTEM FOR ANALYZING HYDROGEN REFUELING ACTION OF FUEL CELL VEHICLE BASED ON BIG DATA PLATFORM

(71) Applicants: CATARC New Energy Vehicle Test Center (Tianjin) Co., Ltd., Tianjin (CN); China Automotive Technology & Research Center Co., Ltd., Tianjin (CN)

(72) Inventors: Zirong YANG, Tianjin (CN); Dong Hao, Tianjin (CN); Yanyi Zhang, Tianjin (CN); Fang Wang, Tianjin (CN); Xiangyang Chen, Tianjin (CN); Yunpeng Yang, Tianjin (CN); Jia Wang, Tianjin (CN); Wenyan Dong, Tianjin (CN); Zhensen Ding, Tianjin (CN); Xiangxiang Wang, Tianjin (CN)

(21) Appl. No.: 18/816,365

(22) Filed: Aug. 27, 2024

(30) Foreign Application Priority Data
Nov. 6, 2023 (CN) 202311466486.3

(51) Int. Cl. B60L 53/54; B60L 53/66

(52) U.S. Cl. CPC B60L 53/54; B60L 53/66; B60L 2240/72; B60L 2260/52; B60L 2260/54

(57) ABSTRACT

The present disclosure relates to a fuel cell technology, and in particular, to a method and a system for analyzing hydrogen refueling action of a fuel cell vehicle based on a big data platform. By extracting a structural design parameter set of a hydrogen system of a fuel cell vehicle and a driving data set of the fuel cell vehicle in a preset time period, and further analyzing the obtained hydrogen refueling action data, it calculates a first hydrogen refueling feature set and a second hydrogen refueling feature set of the fuel cell vehicle and finally obtain hydrogen refueling action features corresponding to driving of the fuel cell vehicle in a preset time period. In the present disclosure, it analyzes hydrogen refueling features of a fuel cell vehicle based on resources of the big data platform, so it can not only assess an economy and a technical level of the fuel cell vehicle when running on an actual road, but also has an important guiding significance for planning and layout of geographic locations of hydrogen refueling stations and hydrogen refueling capability in an urban group, and is applicable to an analysis requirement of various vehicle models with high coverage, simple operation, and low costs.

### FIELD

The present disclosure relates to fuel cell technologies, and in particular, to a method and a system for analyzing hydrogen refueling action of a fuel cell vehicle based on a big data platform, including.

### BACKGROUND

The proton exchange membrane fuel cell has advantages of high power density, high energy conversion efficiency, and zero emission. It is considered as one of the cleaning power sources with a wide application prospect in the future transportation field.

Compared with a conventional internal combustion engine vehicle in which the fuel is gasoline, diesel, natural gas, and the like, the fuel of the fuel cell vehicle is hydrogen. Hydrogen needs to be refueled in a timely manner to support a vehicle driving requirement. On one hand, current hydrogen stations are not popularized, and a distance between a hydrogen station and another hydrogen station is relatively long, which affects a daily driving requirement and commercialization promotion of the fuel cell vehicle. On the other hand, a hydrogen refueling features such as hydrogen refueling mass and average hydrogen consumption of the fuel cell vehicle also affects costs for users. Therefore, with reference to resources of a big data platform, analysis for vehicle hydrogen refueling can not only obtain a degree of dependence of a fuel cell vehicle on a fuel cell system as a power source during actual driving, so as to evaluate a technical maturity of the fuel cell vehicle, but also has an important guiding significance for planning and layout of geographic locations of hydrogen refueling stations and hydrogen refueling capability. In this method, a large quantity of samples of fuel cell vehicles can be covered, a vehicle distribution area is wide, and an analysis cost is low.

### SUMMARY

According to a first aspect of the present disclosure, the present disclosure requests to protect a method for analyzing hydrogen refueling action of a fuel cell vehicle based on a big data platform, including:
extracting, from the big data platform for the fuel cell vehicle, a structural design parameter set of a hydrogen system of a fuel cell vehicle and a driving data set A1 of the fuel cell vehicle in a preset time period;
extracting a hydrogen refueling data set A2 related to the hydrogen refueling action of the fuel cell vehicle based on the driving data set A1;
identifying, based on the hydrogen refueling data set A2, the occurrence of the hydrogen refueling action of the fuel cell vehicle by using a preset logical judgement condition, and determining respective data rows before and after the hydrogen refueling of the fuel cell vehicle;
obtaining attribute change values of the fuel cell vehicle after the occurrence of the hydrogen refueling action of the fuel cell vehicle by using the respective data rows before and after the hydrogen refueling of the fuel cell vehicle, and calculating hydrogen refueling mass of the fuel cell vehicle;
calculating a first hydrogen refueling feature set of the fuel cell vehicle based on all hydrogen refueling action data in the hydrogen refueling data set A2;
obtaining a second hydrogen refueling feature set corresponding to all hydrogen refueling actions in the hydrogen refueling data set A2 based on the hydrogen refueling mass and the first hydrogen refueling feature set of the fuel cell vehicle, and plotting hydrogen refueling action features corresponding to driving of the fuel cell vehicle in the preset time period.

According to a second aspect of the present disclosure, the present disclosure requests to protect a system for analyzing hydrogen refueling action of a fuel cell vehicle based on a big data platform, comprising:
a memory, configured to store non-temporary computer readable instructions; and
a processor, configured to record computer readable instructions when executed by the processor implements the method for analyzing hydrogen refueling action of a fuel cell vehicle based on a big data platform.

The present disclosure relates to a fuel cell technology, and in particular, to a method and a system for analyzing hydrogen refueling action of a fuel cell vehicle based on a big data platform. By extracting a structural design parameter set of a hydrogen system of a fuel cell vehicle and a driving data set of the fuel cell vehicle in a preset time period, and further analyzing the obtained hydrogen refueling action data, it calculates a first hydrogen refueling feature set and a second hydrogen refueling feature set of the fuel cell vehicle and finally obtain hydrogen refueling action features corresponding to driving of the fuel cell vehicle in a preset time period. In the present disclosure, it analyzes hydrogen refueling features of a fuel cell vehicle based on resources of the big data platform, so it can not only assess an economy and a technical level of the fuel cell vehicle when running on an actual road, but also has an important guiding significance for planning and layout of geographic locations of hydrogen refueling stations and hydrogen refueling capability in an urban group, and is applicable to an analysis requirement of various vehicle models with high coverage, simple operation, and low costs.

### DESCRIPTION OF DRAWINGS

FIG. 1 is a working flowchart of a method for analyzing hydrogen refueling action of a fuel cell vehicle based on a big data platform according to an embodiment of the present disclosure;

FIG. 2 is a schematic diagram of a distribution of hydrogen refueling interval distances in a method for analyzing hydrogen refueling action of a fuel cell vehicle based on a big data platform according to an embodiment of the present disclosure;

FIG. 3 is a schematic diagram of a distribution of vehicle hydrogen refueling interval times in a method for analyzing hydrogen refueling action of a fuel cell vehicle based on a big data platform according to an embodiment of the present disclosure;

FIG. 4 is a schematic diagram of a distribution of vehicle hydrogen refueling interval distance-interval time in a method for analyzing hydrogen refueling action of a fuel cell vehicle based on a big data platform according to an embodiment of the present disclosure;

FIG. 5 is a schematic diagram of probability distribution of vehicle hydrogen refueling interval distance-interval time in a method for analyzing hydrogen refueling action of a fuel cell vehicle based on a big data platform according to an embodiment of the present disclosure;

FIG. 6 is a schematic diagram of a distribution of pressures of hydrogen tank before and after vehicle hydrogen refueling in a method for analyzing hydrogen refueling action of a fuel cell vehicle based on a big data platform according to an embodiment of the present disclosure;

FIG. 7 is a schematic diagram of a distribution of single vehicle hydrogen refueling mass in a method for analyzing hydrogen refueling action of a fuel cell vehicle based on a big data platform according to an embodiment of the present disclosure;

FIG. 8 is a schematic diagram of a distribution of vehicle average hydrogen consumption per 100 km in a method for analyzing hydrogen refueling action of a fuel cell vehicle based on a big data platform according to an embodiment of the present disclosure;

FIG. 9 is a structural diagram of a system for analyzing hydrogen refueling action of a fuel cell vehicle based on a big data platform according to an embodiment of the present disclosure.

### DETAILED DESCRIPTION

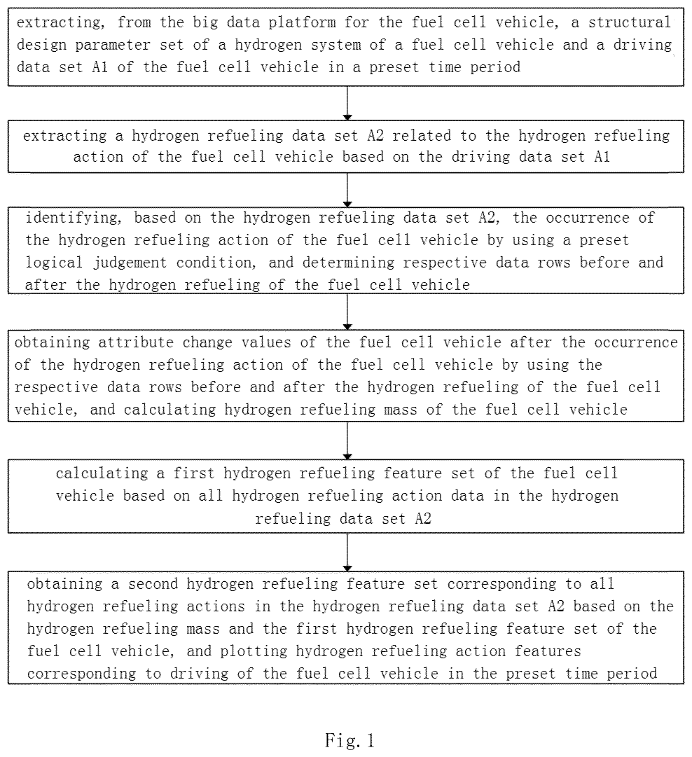

According to a first embodiment of the present disclosure, referring to FIG. 1, the present disclosure seeks to protect a method for analyzing hydrogen refueling action of a fuel cell vehicle based on a big data platform, including:
extracting, from the big data platform for the fuel cell vehicle, a structural design parameter set of a hydrogen system of a fuel cell vehicle and a driving data set A1 of the fuel cell vehicle in a preset time period;
extracting a hydrogen refueling data set A2 related to the hydrogen refueling action of the fuel cell vehicle based on the driving data set A1;
identifying, based on the hydrogen refueling data set A2, the occurrence of the hydrogen refueling action of the fuel cell vehicle by using a preset logical judgement condition, and determining respective data rows before and after the hydrogen refueling of the fuel cell vehicle;
obtaining attribute change values of the fuel cell vehicle after the occurrence of the hydrogen refueling action of the fuel cell vehicle by using the respective data rows before and after the hydrogen refueling of the fuel cell vehicle, and calculating hydrogen refueling mass of the fuel cell vehicle;
calculating a first hydrogen refueling feature set of the fuel cell vehicle based on all hydrogen refueling action data in the hydrogen refueling data set A2;
obtaining a second hydrogen refueling feature set corresponding to all hydrogen refueling actions in the hydrogen refueling data set A2 based on the hydrogen refueling mass and the first hydrogen refueling feature set of the fuel cell vehicle, and plotting hydrogen refueling action features corresponding to driving of the fuel cell vehicle in the preset time period.

Further, the structural design parameter set of the hydrogen system of the fuel cell vehicle includes at least the number of hydrogen storage tanks n_tank, a nominal water volume of the hydrogen storage tanks V_tank, and a nominal operating pressure of the hydrogen storage tanks.

Based on the big data platform of the fuel cell vehicle, a structural design parameters of the hydrogen system of a heavy truck are obtained. The number of hydrogen storage tanks n_tank is 9, the nominal water volume of the hydrogen storage tanks V_tank is 165 L, and the nominal operating pressure of the hydrogen storage tanks is 35.0 MPa.

The hydrogen refueling data set A2 of the hydrogen refueling action of the fuel cell vehicle includes at least information sending time, cumulative mileage, a maximum temperature in the hydrogen system, and a maximum hydrogen pressure.

The first hydrogen refueling feature set of the fuel cell vehicle includes at least a pressure of the hydrogen storage tank before hydrogen refueling of the fuel cell vehicle, a pressure of the hydrogen storage tank after hydrogen refueling of the fuel cell vehicle, a temperature of the hydrogen storage tank before hydrogen refueling of the fuel cell vehicle, and a temperature of the hydrogen storage tank after hydrogen refueling of the fuel cell vehicle.

The second hydrogen refueling feature set includes at least hydrogen refueling interval distances, hydrogen refueling interval times, number of hydrogen refueling, the hydrogen refueling mass, and average hydrogen consumption.

Further, the extracting the hydrogen refueling data set A2 related to the hydrogen refueling action of the fuel cell vehicle based on the driving data set A1 further includes:
Extracting, as the hydrogen refueling data set A2, n rows of data in the driving data set A1 involving the hydrogen refueling action of the fuel cell vehicle, the n rows of data are arranged in a sequence of sending time.
Obtaining the hydrogen refueling data set A2 of the heavy truck in August based on the big data platform of the fuel cell vehicle, and the hydrogen refueling data set A2 is arranged into 56162 rows of data according to the sequence of sending time.

In row m of data in the hydrogen refueling data set A2, the information sending time is represented as Time_m, cumulative mileage is represented as S_m, a maximum temperature in a hydrogen system is represented as Temp_m, and a maximum hydrogen pressure is represented as P_m, where values of Time_m, S_m, Temp_m, and P_m are not null sets and are not zero.

In row 2565 of data in the hydrogen refueling data set A2, information sending time is 2022-08-26 01:48:40, cumulative mileage is 6269.6 km, a maximum temperature in a hydrogen system is 38° C., and a maximum hydrogen pressure is 34.7 MPa.

In row m−1 of data in the hydrogen refueling data set A2, information sending time is represented as Time_m−1, cumulative mileage is represented as S_m−1, a maximum temperature in a hydrogen system is represented as Temp_m−1, and a maximum hydrogen pressure is represented as P_m−1.

In row 2564 of data in the hydrogen refueling data set A2, information sending time is 2022-08-25 15:50:07, cumulative mileage is null set, a maximum temperature in a hydrogen system is null set, and a maximum hydrogen pressure is null set.

Further, the identifying, based on the hydrogen refueling data set A2, the occurrence of the hydrogen refueling action of the fuel cell vehicle by using a preset logical judgement condition, and determining respective data rows before and after the hydrogen refueling of the fuel cell vehicle further includes:

If values of Time_m−1, S_m−1, Temp_m−1, and P_m−1 in the row m of data in the hydrogen refueling data set A2 are neither null nor zero, calculation is performed by using the row m of data and the row m−1 of data.

If values of Time_m−1, S_m−1, Temp_m−1, and P_m−1 in the row m of data in the hydrogen refueling data set A2 are null or zero, a valid data row is traced forward according to the sending time until the valid data row is found, where the data row is represented as the row m-a, and a is in the range of [1, 2, . . . , m−1]. In the row m−a, information sending time is Time_m−a, cumulative mileage is S_m−a, maximum temperature in the hydrogen system is Temp_m−a, and maximum hydrogen pressure is P_m−a.

In the row 2563 of data in the hydrogen refueling data set A2, information sending time is 2022-08-25 15:49:57, cumulative mileage is 6269.6 km, maximum temperature in the hydrogen system is 18° C., and a maximum hydrogen pressure is 13.9 MPa.

If the row m of data and the row m−a of data in the hydrogen refueling data set A2 meet the following logical judgement condition, it is considered that a hydrogen refueling action occurs in the fuel cell vehicle. Otherwise, no hydrogen refueling action occurs.

$$P\_m > P\_m - a + B ;$$

Where, B is a preset pressure change threshold before and after hydrogen refueling. The logical judgement condition is that the hydrogen refueling action of the fuel cell vehicle occurs when a pressure variation in the hydrogen storage tank of the fuel cell vehicle in neighboring data rows exceeds a preset pressure change threshold before and after hydrogen refueling, that is, the hydrogen refueling action of the fuel cell vehicle causes an increase in pressure of the hydrogen storage tank of the fuel cell vehicle.

For the heavy truck, a preset pressure change threshold before and after hydrogen refueling is set to 10 MPa.

In row 2565 of data and row 2563 of data in the hydrogen refueling data set A2, where a pressure variation of the fuel cell vehicle before and after hydrogen refueling is 20.8 MPa, that is, a hydrogen refueling action of the fuel cell vehicle occurs once.

When a hydrogen refueling action occurs for the first time in the hydrogen refueling data set A2, the number of hydrogen refueling is recorded as 1, and each subsequent hydrogen refueling action occurs, the number of hydrogen refueling is increased by 1.

Further, the obtaining attribute change values of the fuel cell vehicle after the occurrence of the hydrogen refueling action of the fuel cell vehicle by using the respective data rows before and after the hydrogen refueling of the fuel cell vehicle, and calculating hydrogen refueling mass of the fuel cell vehicle further includes:
The pressure of the hydrogen storage tank before hydrogen refueling of the fuel cell vehicle is P_before and P_before=13.9 MPa.

The pressure of the hydrogen storage tank after hydrogen refueling of the fuel cell vehicle is P_after and P_after=34.7 MPa.

The temperature of the hydrogen storage tank before hydrogen refueling of the fuel cell vehicle is Temp_before and Temp_before=18° C.

The temperature of the hydrogen storage tank after hydrogen refueling of the fuel cell vehicle is Temp_after and Temp_after=38° C.

Based on the pressures and temperatures of the hydrogen storage tank before and after the hydrogen refueling of the fuel cell vehicle, it calculates the hydrogen storage mass after the hydrogen refueling of the fuel cell vehicle m_tank_after, and the hydrogen storage mass before the hydrogen refueling of the fuel cell vehicle m_tank_before.

$$m\_tank \_before = \frac{P\_before \times V\_tank \times n\_tank \times {M}_{H 2}}{R \times Temp\_before} ;$$

Where, P_before is the pressure of the hydrogen storage tank before hydrogen refueling of the fuel cell vehicle, V_tank is the nominal water volume of the hydrogen storage tank, n_tank is the number of the hydrogen storage tanks, M_{H2} is the molar mass of the hydrogen gas, R is an ideal gas constant, and Temp_before is the temperature of the hydrogen storage tank before hydrogen refueling of the fuel cell vehicle.

The foregoing values are substituting for calculation to obtain that the hydrogen storage mass before hydrogen refueling is 17.05 kg in the hydrogen refueling action.

$$m\_tank \_after = \frac{P\_after \times V\_tank \times n\_tank \times {M}_{H 2}}{R \times Temp\_after} ;$$

Where, P_after is the pressure of the hydrogen storage tank after hydrogen refueling of the fuel cell vehicle, V_tank is the nominal water volume of the hydrogen storage tank, n_tank is the number of the hydrogen storage tanks, M_{H2} is the molar mass of the hydrogen gas, R is an ideal gas constant, and Temp_after is the temperature of the hydrogen storage tank after hydrogen refueling of the fuel cell vehicle.

The foregoing values are substituting for calculation to obtain that the hydrogen storage mass after hydrogen refueling is 39.84 kg in the hydrogen refueling action.

A hydrogen refueling mass of the fuel cell vehicle is calculated by using the hydrogen storage mass of the fuel cell vehicle after hydrogen refueling and the hydrogen storage mass of the fuel cell vehicle before hydrogen refueling.

$$m\_tank \_addmass = m\_tank \_after - m\_tank \_before .$$

Substituting the foregoing the hydrogen storage mass before hydrogen refueling and the hydrogen storage mass after hydrogen refueling for calculation to obtain that the hydrogen refueling mass corresponding to the hydrogen refueling action is 22.79 kg.

Further, the calculating a first hydrogen refueling feature set of the fuel cell vehicle based on all hydrogen refueling action data in the hydrogen refueling data set A2 further includes: The hydrogen refueling interval distance is equal to a difference between the respective accumulative mileages of fuel cell vehicle when two adjacent hydrogen refueling actions occur:

$$H2\_add \_int \_distance = {S\_m}^{′} - S\_m ;$$

Where, H2_add_int_distance represents the hydrogen refueling interval distance, S_m′ represents a cumulative mileage of the fuel cell vehicle when a next hydrogen refueling action occurs, and S_m represents a cumulative mileage of the fuel cell vehicle when a current hydrogen refueling action occurs.

A hydrogen refueling interval time is equal to a difference between the respective information sending times of the fuel cell vehicle when two adjacent hydrogen refueling actions occur:

$$H2\_add \_int \_time = {Time\_m}^{′} - Time\_m ;$$

Where, H2_add_int_time represents the hydrogen refueling interval time, Time_m′ represents the information sending time of the fuel cell vehicle when a next hydrogen refueling action occurs, and Time_m represents the information sending time of the fuel cell vehicle when a current hydrogen refueling action occurs.

Based on the big data platform for the fuel cell vehicle, the data row when a next hydrogen refueling action occurs in the heavy truck is row 16669 of data in the hydrogen refueling data set A2. The information sending time is 2022-08-28 22:35:30, and the cumulative mileage is 6432.3 km.

Substituting the foregoing values for calculation to obtain a hydrogen refueling interval distance of 162.7 km and a hydrogen refueling interval time of 78.7 h.

The average hydrogen consumption is equal to the hydrogen mass consumed between the current hydrogen refueling action and the next hydrogen refueling action of the fuel cell vehicle divided by the hydrogen refueling interval distance.

$$H2\_comp \_rate = \frac{m\_tank \_mass \_comp}{H2\_add \_int \_distance} .$$

Where, H2_comp_rate represents the average hydrogen consumption, m_tank_mass_comp represents hydrogen mass consumed between the current hydrogen refueling action and the next hydrogen refueling action, and its value is a hydrogen storage mass of a fuel cell vehicle after hydrogen refueling for the current hydrogen refueling action minus hydrogen storage mass of a fuel cell vehicle before hydrogen refueling for the next hydrogen refueling action, and H2_add_int_distance represents the hydrogen refueling interval distance between the current hydrogen refueling action and the next hydrogen refueling action.

The foregoing values are substituted for calculation to obtain an average hydrogen consumption of 0.14 kg/km, that is, an average hydrogen consumption of 100 kilometers is 14 kg/100 km.

Further, in the present disclosure, it can plot hydrogen refueling action features corresponding to driving of the fuel cell vehicle in the preset time period.

In this embodiment, a distribution of the hydrogen refueling interval distances, a distribution of the hydrogen refueling interval times, a scatter distribution of the hydrogen refueling interval distance-interval time, a distribution of the hydrogen refueling mass, and a distribution of the average hydrogen consumption may be plotted, so as to obtain hydrogen refueling action features corresponding to driving of the fuel cell vehicle in the preset time period, thereby providing references for hydrogen refueling rule analysis of the fuel cell vehicle, geographical locations of hydrogen refueling stations in a city group, and planning and layout of a hydrogen refueling capability.

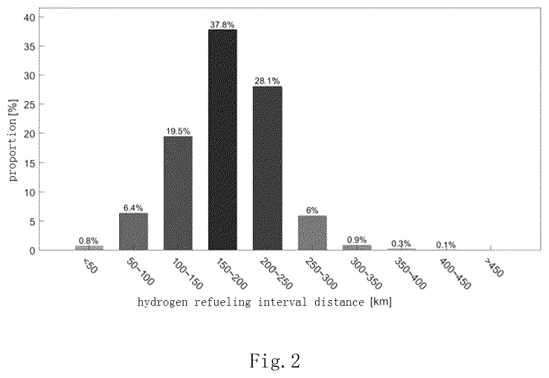

Referring to FIG. 2, the hydrogen refueling action features may include at least a distribution of the vehicle hydrogen refueling interval distances. As shown in the figure, the hydrogen refueling interval distances and the proportions thereof are generally normally distributed. The proportion increases gradually with the increase of the hydrogen refueling interval distance. Subsequently, when the hydrogen refueling interval distance further increases, the proportion decreases gradually.

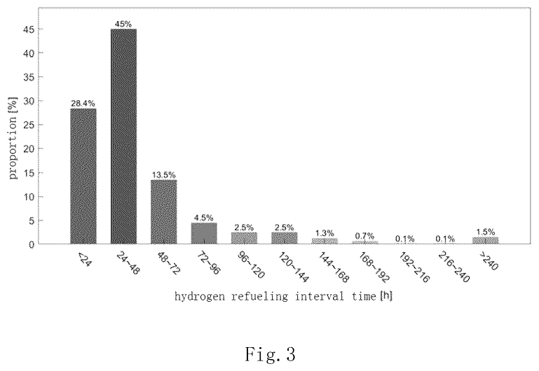

Referring to FIG. 3, the hydrogen refueling action features further include at least a distribution of vehicle hydrogen refueling interval times. As shown in the figure, respective proportions of hydrogen refueling interval times of less than 24 hours, 24 h˜48 h, and 48 h˜72 h are 28.4%, 45%, and 13.5%, respectively, and a total of 86.9%. It should be noted that 3.7% of the hydrogen refueling actions occur in an interval of more than 120 hours, which indicates that some vehicles may be in an untraveled state in some days or some vehicles are over dependent on a power battery system during driving, resulting in a long hydrogen refueling interval.

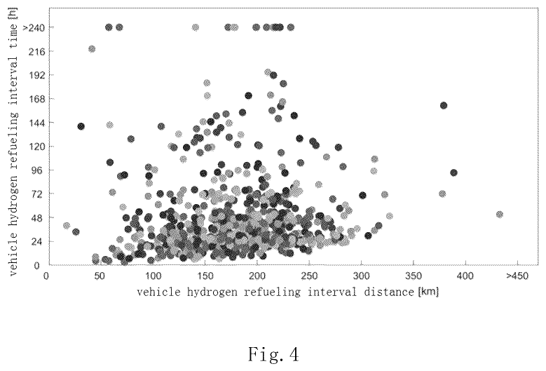

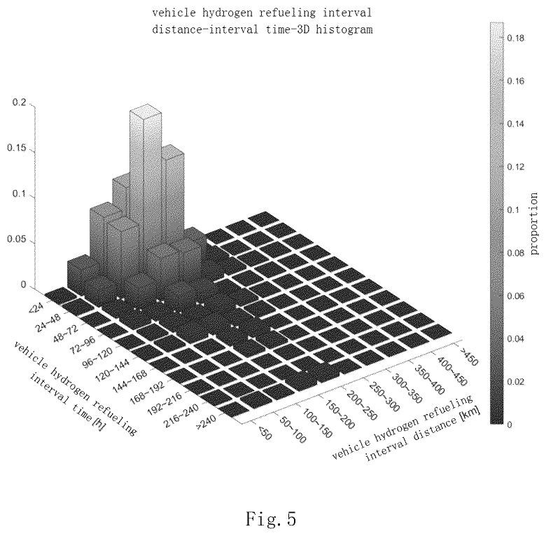

Referring to FIG. 4, the hydrogen refueling action features further include at least a distribution of vehicle hydrogen refueling interval distance-interval time. As shown in the figure, the hydrogen refueling interval distance is mainly distributed in a range of 50 km˜300 km, and the hydrogen refueling interval times are mainly concentrated in a range of 0˜96 h, and very few hydrogen refueling actions in which the vehicle hydrogen refueling interval distance is greater than 350 km or the hydrogen refueling interval time exceeds 192 h occur. Referring to FIG. 5, the hydrogen refueling action features further include at least a probability distribution of vehicle hydrogen refueling interval distance-interval time. As shown in the figure, range of most intensive hydrogen refueling actions is: the hydrogen refueling interval distance of 150 km˜200 km and the hydrogen refueling interval time of 24 h˜48 h, with a proportion of 18%, followed by the hydrogen refueling interval distance of 200 km˜250 km and the hydrogen refueling interval time of 24 h˜48 h, with a proportion of 14%. The hydrogen continuous driving distance of vehicle is 340 km. Therefore, the area with the most intensive hydrogen refueling actions in the fleet is 50% hydrogen continuous driving distance, which is related to the construction of the local hydrogen refueling stations and geographical location layout.

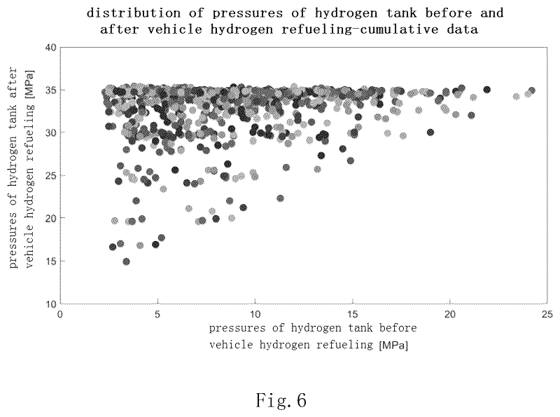

Referring to FIG. 6, the hydrogen refueling action features further include at least distribution of pressures of hydrogen tank before and after vehicle hydrogen refueling. As shown in the figure, the distribution of pressures of hydrogen tank before hydrogen refueling is relatively wide, and is distributed from 3 MPa to 20 MPa. The pressures of hydrogen tank after hydrogen refueling are mainly concentrated in 25 MPa-35 MPa, and a small quantity of scatters are distributed in other areas. The pressures after hydrogen refueling are the most concentrated around 35 MPa, which indicates that the hydrogen refueling actions are all in the hydrogen-filled state. In addition, there is a certain distribution around 30 MPa.

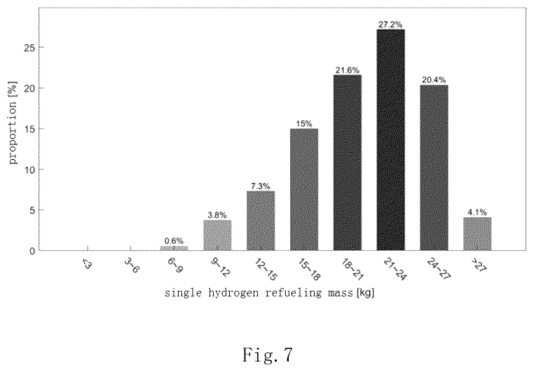

Referring to FIG. 7, the hydrogen refueling action features further include at least a distribution of single vehicle hydrogen refueling mass. As shown in the figure, with the increase of single hydrogen refueling mass, the proportion thereof increases first and then decreases. The single hydrogen refueling mass is mainly concentrated on 18 kg˜21 kg, 21 kg˜24 kg, and 24 kg˜27 kg, with respective proportions of 21.6%, 27.2%, and 20.4%. Only 4.4% of the single hydrogen refueling mass is less than 12 kg.

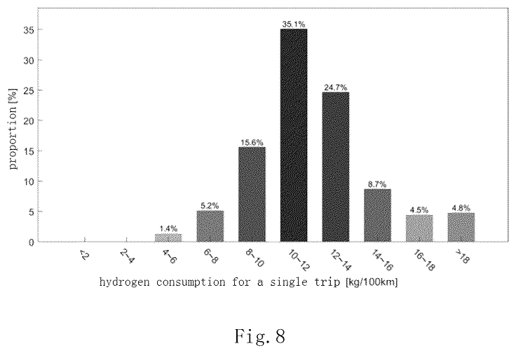

Referring to FIG. 8, the hydrogen refueling action features further include at least a distribution of vehicle average hydrogen consumption per 100 km. As shown in the figure, the proportion of the average hydrogen consumption distributed in the 10 kg/100 km˜12 kg/100 km is the highest, reaching 35.1%, followed by a range of 12 kg/100 km˜14 kg/100 km. By comparing the hydrogen consumptions of different vehicles, the hydrogen consumption is related to different vehicle models, transport operation load, ambient temperature, and respective technical differences.

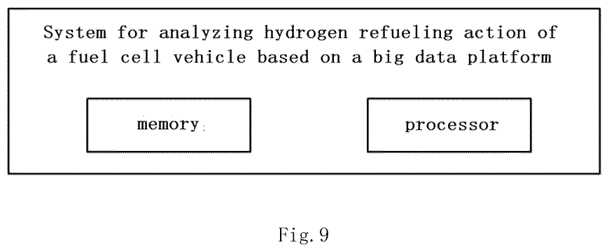

According to a second embodiment of the present disclosure, referring to FIG. 9, the present disclosure seeks to protect a system for analyzing hydrogen refueling action of a fuel cell vehicle based on a big data platform, including:
a memory, configured to store non-temporary computer readable instructions; and
a processor, configured to record computer readable instructions when executed by the processor implements a method for analyzing hydrogen refueling action of a fuel cell vehicle based on a big data platform.

A person skilled in the art can understand that various variations and improvements may occur to the content disclosed in this disclosure. For example, various devices or components described above may be implemented by hardware, or may be implemented by software, firmware, or some or all combinations of the three.

A flowchart is used in this disclosure to describe the steps of the method according to the embodiments of this disclosure. It should be understood that the preceding or subsequent steps are not necessarily performed in an exact order. On the contrary, various steps may be processed in reverse order or at the same time. In addition, other operations may be added to these processes.

A person of ordinary skill in the art may understand that all or a part of the steps in the foregoing methods may be completed by a computer program instructing related hardware, and the program may be stored in a computer readable storage medium, such as a read-only memory, a magnetic disk, or an optical disc. Optionally, all or a part of the steps of the foregoing embodiment may also be implemented by using one or more integrated circuits.

Correspondingly, each module/unit in the foregoing embodiment may be implemented in a form of hardware, or may be implemented in a form of a software function module. This disclosure is not limited to any specific form of combination of hardware and software.

Unless otherwise defined, all terms used herein have the same meaning as those of ordinary skill in the art to which this disclosure belongs. It should also be understood that terms such as those defined in the usual dictionaries should be interpreted as having meanings consistent with their meanings in the context of the related art, without applying idealized or extremely formalized meanings, unless expressly defined herein.

The foregoing is a description of this disclosure and should not be considered a limitation. Although several exemplary embodiments of the present disclosure are described, those skilled in the art will readily appreciate that many modifications may be made to the exemplary embodiments without departing from the novel teachings and advantages of the present disclosure. Therefore, all such modifications are intended to be included within the scope of this disclosure as defined in the claims. It should be understood that the foregoing descriptions of this disclosure are not intended to be limited to the specific embodiments disclosed, and modifications to the disclosed embodiments and other embodiments are intended to be included within the scope of the appended claims. This disclosure is defined by the claims and their equivalents.

In the description of this specification, reference to the description of the term “one embodiment”, “some embodiments”, “exemplary embodiments”, “examples”, “specific examples”, or “some examples” means that specific features, structures, materials, or features described with reference to this embodiment or example are included in at least one embodiment or example of the present disclosure. In this specification, a schematic description of the foregoing term does not necessarily refer to the same embodiment or example. Furthermore, specific features, structures, materials, or features described may be incorporated in an appropriate manner in any one or more embodiments or examples.

Although embodiments of the present disclosure have been shown and described, a person of ordinary skill in the art may understand that, without departing from the principles and objects of the present disclosure, various variations, modifications, replacements, and variations may be made to these embodiments, and the scope of the present disclosure is limited by claims and equivalents thereof.

1. A method for analyzing hydrogen refueling action of a fuel cell vehicle based on a big data platform, comprising:
extracting, from the big data platform for the fuel cell vehicle, a structural design parameter set of a hydrogen system of the fuel cell vehicle and a driving data set A1 of the fuel cell vehicle in a preset time period;
extracting a hydrogen refueling data set A2 related to the hydrogen refueling action of the fuel cell vehicle based on the driving data set A1;
identifying, based on the hydrogen refueling data set A2, the occurrence of the hydrogen refueling action of the fuel cell vehicle by using a preset logical judgement condition, and determining respective data rows before and after the hydrogen refueling of the fuel cell vehicle;
obtaining attribute change values of the fuel cell vehicle after the occurrence of the hydrogen refueling action of the fuel cell vehicle by using the respective data rows before and after the hydrogen refueling of the fuel cell vehicle, and calculating hydrogen refueling mass of the fuel cell vehicle;
calculating a first hydrogen refueling feature set of the fuel cell vehicle based on all hydrogen refueling action data in the hydrogen refueling data set A2;
obtaining a second hydrogen refueling feature set corresponding to all hydrogen refueling actions in the hydrogen refueling data set A2 based on the hydrogen refueling mass and the first hydrogen refueling feature set of the fuel cell vehicle, and plotting hydrogen refueling action features corresponding to driving of the fuel cell vehicle in the preset time period;
the structural design parameter set of the hydrogen system of the fuel cell vehicle includes at least the number of hydrogen storage tanks n_tank, a nominal water volume of the hydrogen storage tanks V_tank, and a nominal operating pressure of the hydrogen storage tanks;
the hydrogen refueling data set A2 of the hydrogen refueling action of the fuel cell includes at least an information sending time, an accumulated mileage, a highest temperature in a hydrogen system, and a highest hydrogen pressure;
the first hydrogen refueling feature set of the fuel cell vehicle includes at least a pressure of the hydrogen storage tank before hydrogen refueling of the fuel cell vehicle, a pressure of the hydrogen storage tank after hydrogen refueling of the fuel cell vehicle, a temperature of the hydrogen storage tank before hydrogen refueling of the fuel cell vehicle, and a temperature of the hydrogen storage tank after hydrogen refueling of the fuel cell vehicle;
the second hydrogen refueling feature set includes at least hydrogen refueling interval distance, hydrogen refueling interval time, the number of hydrogen refueling, the hydrogen refueling mass, and average hydrogen consumption;
the obtaining a second hydrogen refueling feature set corresponding to all hydrogen refueling actions in the hydrogen refueling data set A2 based on the hydrogen refueling mass and the first hydrogen refueling feature set of the fuel cell vehicle further comprises:
the hydrogen refueling interval distance is equal to a difference between the respective accumulative mileages of fuel cell vehicle when two adjacent hydrogen refueling actions occur:
$$H2\_add \_int \_distance = {S\_m}^{′} - S\_m ;$$
wherein, H2_add_int_distance represents the hydrogen refueling interval distance, S_m′ represents the cumulative mileage of the fuel cell vehicle when a next hydrogen refueling action occurs, and S_m represents the cumulative mileage of the fuel cell vehicle when a current hydrogen refueling action occurs;
the hydrogen refueling interval time is equal to a difference between the respective information sending times of the fuel cell vehicle when two adjacent hydrogen refueling actions occur:
$$H2\_add \_int \_time = {Time\_m}^{′} - Time\_m ;$$
wherein, H2_add_int_time represents the hydrogen refueling interval time, Time_m′ represents the information sending time of the fuel cell vehicle when a next hydrogen refueling action occurs, and Time_m represents the information sending time of the fuel cell vehicle when a current hydrogen refueling action occurs;
the average hydrogen consumption is equal to the hydrogen mass consumed between the current hydrogen refueling action and the next hydrogen refueling action of the fuel cell vehicle divided by the hydrogen refueling interval distance:
$$H2\_comp \_rate = \frac{m\_tank \_mass \_comp}{H2\_add \_int \_distance} ;$$
wherein, H2_comp_raterepresents the average hydrogen consumption, m_tank_mass_comp represents hydrogen mass consumed between the current hydrogen refueling action and the next hydrogen refueling action, and its value is a hydrogen storage mass of a fuel cell vehicle after hydrogen refueling for the current hydrogen refueling action minus hydrogen storage mass of a fuel cell vehicle before hydrogen refueling for the next hydrogen refueling action, H2_add_int_distance represents the hydrogen refueling interval distance between the current hydrogen refueling action and the next hydrogen refueling action.

2. The method for analyzing hydrogen refueling action of a fuel cell vehicle based on a big data platform according to claim 1, wherein the extracting the hydrogen refueling data set A2 related to the hydrogen refueling action of the fuel cell vehicle based on the driving data set A1 further comprises:
extracting, as the hydrogen refueling data set A2, n rows of data in the driving data set A1 involving the hydrogen refueling action of the fuel cell vehicle, the n rows of data are arranged in a sequence of sending time;
in row m of data in the hydrogen refueling data set A2, the information sending time is represented as Time_m, a cumulative mileage is represented as S_m, a maximum temperature in a hydrogen system is represented as Temp_m, and a maximum hydrogen pressure is represented as P_m, where values of Time_m, S_m, Temp_m, and P_m are not null sets and are not zero;
in row m−1 of data in the hydrogen refueling data set A2, information sending time is represented as Time_m−1, cumulative mileage is represented as S_m−1, a maximum temperature in a hydrogen system is represented as Temp_m−1, and a maximum hydrogen pressure is represented as P_m−1.

3. The method for analyzing hydrogen refueling action of a fuel cell vehicle based on a big data platform according to claim 2, wherein the identifying, based on the hydrogen refueling data set A2, the occurrence of the hydrogen refueling action of the fuel cell vehicle by using a preset logical judgement condition, and determining respective data rows before and after the hydrogen refueling of the fuel cell vehicle further comprises:
if values of Time_m−1, S_m−1, Temp_m−1, and P_m−1 in the row m−1 of data in the hydrogen refueling data set A2 are neither null nor zero, calculation is performed by using the row m of data and the row m−1 of data;
if values of Time_m−1, S_m−1, Temp_m−1, and P_m−1 in the row m−1 of data in the hydrogen refueling data set A2 are null or zero, a valid data row is traced forward according to the sending time until the valid data row is found, wherein the data row is represented as the row m−a, and a is in the range of [1, 2, . . . , m−1], in the row m−a, information sending time is Time_m−a, cumulative mileage is S_m−a, maximum temperature in the hydrogen system is Temp_m−a, and maximum hydrogen pressure is P_m−a;
if the row m of data and the row m−a of data in the hydrogen refueling data set A2 meet the following logical judgement condition, it is considered that a hydrogen refueling action occurs in the fuel cell vehicle, otherwise, no hydrogen refueling action occurs;
$$P\_m > P\_m - a + B ;$$
wherein, B is a preset pressure change threshold before and after hydrogen refueling, the logical judgement condition is that the hydrogen refueling action of the fuel cell vehicle occurs when a pressure variation in the hydrogen storage tank of the fuel cell vehicle in neighboring data rows exceeds a preset pressure change threshold before and after hydrogen refueling;
when the hydrogen refueling action occurs for the first time in the hydrogen refueling data set A2, the number of hydrogen refueling is recorded as 1, and each subsequent hydrogen refueling action occurs, the number of hydrogen refueling is increased by 1.

4. The method for analyzing hydrogen refueling action of a fuel cell vehicle based on a big data platform according to claim 3, wherein obtaining attribute change values of the fuel cell vehicle after the occurrence of the hydrogen refueling action of the fuel cell vehicle by using the respective data rows before and after the hydrogen refueling of the fuel cell vehicle, and calculating hydrogen refueling mass of the fuel cell vehicle further comprises:
the pressure of the hydrogen storage tank before hydrogen refueling of the fuel cell vehicle is P_before, and P_before=P_m−a;
the pressure of the hydrogen storage tank after hydrogen refueling of the fuel cell vehicle is P_after, and P_after=P_m;
the temperature of the hydrogen storage tank before hydrogen refueling of the fuel cell vehicle is Temp_before, and Temp_before=Temp_m−a;
the temperature of the hydrogen storage tank after hydrogen refueling of the fuel cell vehicle is Temp_after, and Temp_after=Temp_m;
calculating the hydrogen storage mass after the hydrogen refueling of the fuel cell vehicle m_tank_after, and the hydrogen storage mass before the hydrogen refueling of the fuel cell vehicle m_tank_before, based on the pressures and temperatures of the hydrogen storage tank before and after the hydrogen refueling of the fuel cell vehicle:
$$m\_tank \_before = \frac{P\_before \times V\_tank \times n\_tank \times {M}_{H 2}}{R \times Temp\_before} ;$$
wherein, V_tank is the nominal water volume of the hydrogen storage tank, n_tank is the number of the hydrogen storage tanks, M_{H2} is the molar mass of the hydrogen gas, R is an ideal gas constant;
$$m\_tank \_after = \frac{P\_after \times V\_tank \times n\_tank \times {M}_{H 2}}{R \times Temp\_after}$$
the hydrogen refueling mass of the fuel cell vehicle is calculated by using the hydrogen storage mass of the fuel cell vehicle after hydrogen refueling and the hydrogen storage mass of the fuel cell vehicle before hydrogen refueling:
$$m\_tank \_addmass = m\_tank \_after - m\_tank \_before .$$

5. A system for analyzing hydrogen refueling action of a fuel cell vehicle based on a big data platform, comprising:
a memory, configured to store non-temporary computer readable instructions; and
a processor, configured to record computer readable instructions when executed by the processor implements the method for analyzing hydrogen refueling action of a fuel cell vehicle based on a big data platform according to claim 1.
